(19) United States
(12) Patent Application Publication
(10) Pub. No.: US 2001/0006909 A1
(43) Pub. Date: Jul. 5, 2001

(54) SPEECH GENERATING DEVICE AND METHOD IN GAME DEVICE, AND MEDIUM FOR SAME

(76) Inventors: HIROFUMI MIRASAKI, TOKYO (JP); TAKEHIRO KAMINAGAYOSHI, TOKYO (JP)

Correspondence Address: LACKENBACH SIEGEL MARZULLO ARONSON, & GREENSPAN, ONE CHASE ROAD, SCARSDALE, NY, 10583

(21) Appl. No.: 08/828,417

(22) Filed: Mar. 28, 1997

(30) Foreign Application Priority Data
Jan. 30, 1997 (JP) 9-17136

(51) Int. Cl. G06F 19/00; G06F 17/00

(52) U.S. Cl. 463/35; 463/43

(57) ABSTRACT

In a soccer game provided with a running commentary function, the object is to avoid the game becoming mannered and to prevent the players from losing interest, by changing to contents of the running commentary. There are provided a phrase database BOX 1a which stores a plurality of phrase data, and an alternative phase database BOX 1b based on a different commentator, and in predetermined cases, running commentary is provided by substituting the alternative phrase database BOX 1b for the phrase database BOX 1a.

### BACKGROUND OF THE INVENTION

1. Field of the Invention

In a game device and particularly, a video game or the like simulating a ball game, such as baseball or soccer, this invention relates to a speech generating device and method for recreating the conditions of a contest, and to a medium whereon programs for causing a computer to implement the relevant processing are recorded.

2. Description of the Related Art

With progress in computer technology, video game devices using computer graphics technology have become widely used. Of these, video game devices simulating ball games, such as baseball or soccer, are especially popular, and many video game devices of this type have been proposed. In games of this kind, in some cases, speech which simulates running commentary of a real match are generated as sound effects during a game. For example, in Japanese Patent 2552425 (Japanese Patent Application 5-313705), a game device is disclosed, which provides running commentary by means of previously recording commentary word data corresponding to the state of progress of a game and the operations implemented, and then specifying running commentary word data according to the state of progress of a game and the operations implemented and converting this data to speech at audible speed.

The prior art involves systems which output speech corresponding to certain conditions in the state of progress of a game and the operations implemented, so there is a 1:1 relationship between the conditions and the output speech. Therefore, since the same words(phrase) is output each time the same condition arises, the game unavoidably becomes mannered and the players may lose interest in the game. Moreover, in games where the state of the game is described by spoken running commentary, if the commentator is always the same, then the game unavoidably becomes mannered.

### SUMMARY OF THE INVENTION

This invention was devised in order to overcome problems of this kind, an object thereof being to provide a speech generating device and method in a game device, whereby there is variation in the content of the speech generated such that the game is prevented from becoming mannered and players are not caused to lose interest, and a medium whereon programs for implementing relevant processing in a computer are recorded.

This invention comprises: a plurality of phrase databases for storing a plurality of phrases respectively, corresponding to a plurality of predetermined conditions; a processing section for monitoring the state of progress of a game, selecting one or more of said plurality of phrase databases, which matches monitored the state, and selecting and outputting one or more data of said plurality of phrases from said selected phrase databases on the basis of a predetermined procedure; and a speech output device for receiving said phrase data from said processing section, converting said phrase data to an audio signal and outputting speech on the basis of said audio signal.

The phrase databases may, for example, be read from a CD-ROM and loaded into a main memory, as and when necessary. Alternative phrase databases may be read in a similar manner. A ROM or hard disk memory, or the like, may also be used.

This invention comprises: phrase databases for storing a plurality of phrases respectively, corresponding to a plurality of predetermined conditions; a processing section for monitoring a state of progress of a game, and selecting and outputting corresponding phrase data from said phrase databases upon occurrence of predetermined conditions; a speech output device for receiving said phrase data from said processing section, converting said phrase data to an audio signal and outputting speech on the basis of said audio signal; and alternative phrase databases including different contents to said phrase databases, wherein said processing section selects and outputs phrase data corresponding to said state from said alternative phrase databases, instead of from said phrase databases, in predetermined cases.

This invention is also a medium whereon programs for causing devices to function as either a processing section, or as a speech output device, are recorded.

This medium may comprise, for example, a floppy disk, hard disk, magnetic tape, optomagnetic disk, CD-ROM, DVD, ROM cartridge, RAM cartridge with battery back-up, flash memory cartridge, fixed RAM cartridge, or the like.

Furthermore, it may also comprise communications media, for instance, a wired communications medium, such as a telephone circuit, or a radio communications medium, such as a microwave circuit. The term “communications medium” used here also includes the Internet.

A medium is something upon which information (mainly digital data and programs) is stored by physical means of some kind, whereby it is able to cause a processing device, such as a computer or special processor, or the like, to implement prescribed functions. In brief, it downloads programs to a computer by some means, thereby causing it to carry out prescribed functions.

This invention comprises: a phrase data selecting step for monitoring a state of progress of a game and, in the event of predetermined conditions arising, selecting and outputting corresponding phrase data from said phrase databases wherein a plurality of phrases corresponding respectively to a plurality of predetermined conditions are stored; and a speech outputting step for receiving said phrase data from said processing section, converting said phrase data to an audio signal and outputting speech on the basis of said audio signal.

### BRIEF DESCRIPTION OF THE DRAWINGS

FIG. 1 is an external view of a video game device relating to a first mode from implementing this invention;

FIG. 2 is an approximate structural view of a video game device relating to a first mode for implementing this invention;

FIG. 3 is a conceptual view showing basic steps for outputting running commentary in a first mode for implementing this invention;

FIG. 4 is a conceptual view showing the detailed structure of a “box” in a first mode for implementing this invention;

FIG. 5 is a flow-chart of processing in a first mode for implementing this invention;

FIG. 6 is a flow-chart of analytical processing of words commands in a first mode for implementing this invention; and

FIG. 7 is a conceptual view showing basic steps for outputting switchable running commentary in a first mode for implementing this invention.

### DESCRIPTION OF THE PREFERRED EMBODIMENTS

### First Mode for Implementing the Invention

Structure of Device

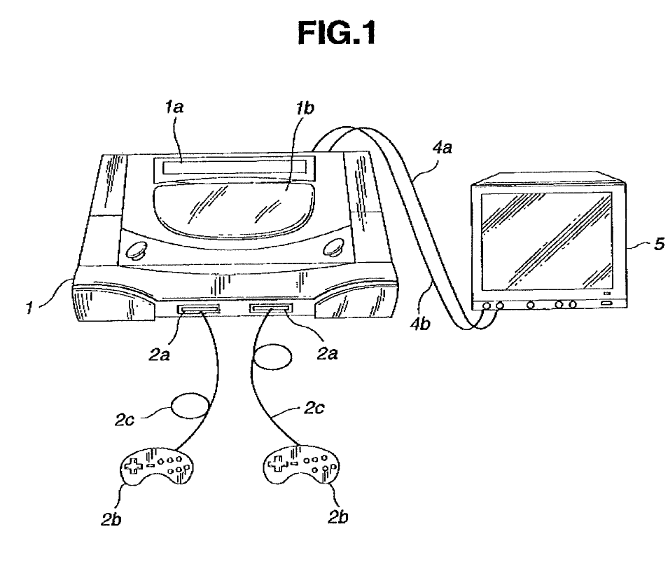

FIG. 1 is an external view of a video game device using an image processing device relating to a first mode for implementing this invention. In this diagram, the main video game device unit 1 forms an approximately box-like shape, and circuit boards and the like for game processing are provided therein. Furthermore, two connectors 2a are provided on the front of the video game device main unit 1 and PADs 2b for game operation are connected via cables 2c to connectors 2a. If two people are playing a game, of baseball or the like, then two PADs 2b are used.

A cartridge I/F 1a for connecting a ROM cartridge and a CD-ROM drive 1b for reading a CD-ROM are provided on the upper portion of the video game device main unit 1.

A video output terminal and an audio terminal are provided on the rear side of the video game device main unit 1, although these are omitted from the drawings. The video output terminal is connected via a cable 4a to a video input terminal of a TV receiver 5, and the audio output terminal is connected via a cable 4b to an audio terminal of the TV receiver 5. In a video game device of this kind, users are able to play a game whilst watching screens displayed on the TV receiver 5 by operating the PADs 2b.

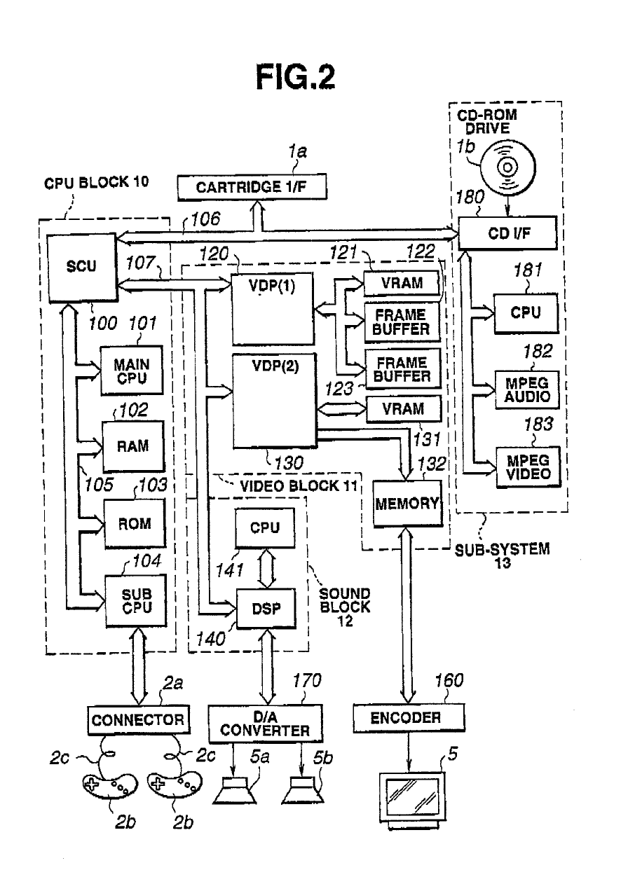

FIG. 2 is a block diagram showing an overview of a TV game device relating to the present embodiment. This image processing device is constituted by; a CPU block 10 which controls the whole device; a video block 11 which controls the display of game screens; a sound block 12 which generates sound effects, and the like; and a subsystem 13 which reads a CD-ROM, or the like.

The CPU block 10 is constituted by: an SCU (System Control Unit) 100; a main CPU 101; a RAM 102; a ROM 103; a cartridge I/F 1a; a sub-CPU 104; a CPU bus 105, and the like. The main CPU 101 controls the whole device. This main CPU 101 is provided internally with a computing function similar to a DSP (Digital Signal Processor), and it is capable of running application software at high speed. The RAM 102 is used as the work area of the main CPU 101. The ROM 103 contains initial programs for initialization processing, and the like. The SCU 100 implements smooth data input/output between the main CPU 101, VDPs 120 and 130, a DSP 140, a CPU 141, and the like, by controlling buses 105, 106 and 107. Furthermore, the SCU 100 is provided internally with a DMA controller, whereby it is able to transfer sprite data during the game to a VRAM in the video block 11. By this means, it is possible to run application software for a game, or the like, at high speed. The cartridge I/F 1a is used for inputting application software supplied in the form of a ROM cartridge.

The sub-CPU 104 is called an SMPC (System Manager and Peripheral Control), and it is provided with a function for gathering peripheral data from the PADs 2b via the connectors 2a, in response to requests from the main CPU 101. The main CPU 101 carries out processing, such as moving competitors on the game screen, for example, on the basis of the peripheral data received from the sub-CPU 104. A PAD, joystick, keyboard, or other desired peripheral can be connected to the connectors 2a. The sub-CPU 104 is provided with a function whereby it automatically confirms the type of peripheral connected to the connectors 2a (main unit terminal) and gathers peripheral data and the like by means of a communication system corresponding to that peripheral type.

The video block 11 is provided with a VDP (Video Display Processor) which draw characters and the like consisting of polygon data for the video game and a VDP 130 which draws background screens, synthesizes the polygon image data and background images, and conducts clipping processes and the like. The VDP 120 is connected to a VRAM 121 and frame buffers 122, 123. Picture data for polygons representing characters in the video game device are transferred from the main CPU 101 via the SCU 100 to the VDP 120, and are written into the VRAM 121. The picture data written into the VRAM 121 is then, for example, drawn into picture frame buffer 122 or 123 in a 16 or 8 bit/pixel format. Data drawn into frame buffer 122 or 123 is transferred to the VDP 130. Information for controlling the drawing process is supplied to the VDP 120 from the main CPU 101 via the SCU 100. The VDP 120 conducts picture processing in accordance with these instructions.

The VDP 130 is connected to a VRAM 131, and is constructed such that image data from the VDP 130 is output to an encoder 160 via a memory 132. The encoder 160 generates a video signal by appending a synchronization signal, or the like, to this image data, and it outputs this video signal to the TV receiver 5. Thereby, screens of a baseball game are displayed on the TV receiver 5.

The sound block 12 is constituted by a DSP 140 which synthesizes speech by means of a PCM method or FM method, and a CPU which controls this DSP 140, and the like. Speech data generated by the DSP 140 is converted to a two-channel signal by a D/A converter 170 and is then output to a speaker 5b.

The subsystem 13 is constituted by a CD-ROM drive 1b, a CD I/F 180, a CPU 181, an MPEG AUDIO 182, an MPEG VIDEO 183, and the like. This subsystem is provided with a function whereby application software provided in CD-ROM format is read and moving pictures are reproduced, and the like. The CD-ROM drive reads out data from a CD-ROM. The CPU 181 controls the CD-ROM drive 1b and conducts processing, such as error correction of the data read out. Data read from the CD-ROM is supplied via the CD I/F 180, bus 106 and SCU 100 to the main CPU 101, where it is used as application software. The MPEG AUDIO 182 and MPEG VIDEO 183 are devices which restore data compressed according to MPEG standards (Motion Picture Expert Group). Moving pictures can be reproduced by restoring MPEG-compressed data read from the CD-ROM using these MPEG AUDIO 182 and MPEG VIDEO 183 devices.

Description of Operation

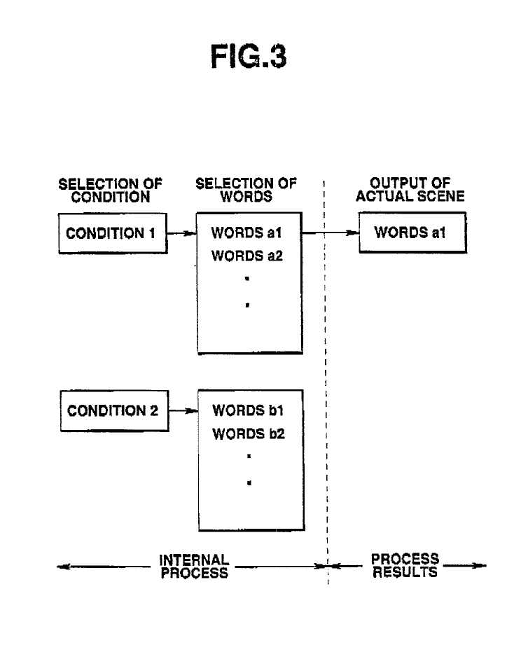

FIG. 3 is a conceptual diagram showing the basic steps for outputting running commentary in a first mode for implementing this invention. According to this diagram, when a predetermined condition (condition 1, condition 2, . . . ) occurs during a game, a corresponding group of words (phrase) (in the case of condition 1: words A1, A2, . . . ; in the case of condition 2: words B1, B2, . . . ) are selected. In the following description, a words group, which is a collection of a plurality of these words, is termed a “box”. A words group is formed by collecting a plurality of interrelated words. Any one of the plurality of words from each “box” is selected randomly, this words is transferred to the sound block 12 as a running commentary output, and it is output via speakers 5a and 5b.

Below, a specific example based on the case of a soccer game, is described in detail.

Examples of conditions include: “Player keeps possession of ball”, “Passes in own half of pitch”, “Runs with ball in own half of pitch”, “Long pass up-field”, “Action by goalkeeper”, “Action by forward”, “Action by midfielder”, “Play switched to other side”, “State of formation”, and the like. In this way, the conditions can be used to classify the action of the players.

There is at least one “box” corresponding to each of the respective conditions. Each box contains a plurality of mutually related words. For example, the following words might be used in the case of the condition “Player keeps possession of ball”. “(Player's name), what's he going to do here?” “He's advancing cautiously, (Player's name)” “How's he going to feed the ball through to the forwards” “(Player's name) is keeping tight control of the ball.”

Here, “(Player's name)” is automatically filled by the name of the player in possession of the ball at that point in the game. The relevant processing is described later.

In this way, a words group in a “box” is a collection of a plurality of words which one might expect to arise in running commentary in the event of that particular condition, for example, a forecast about where the player will move, the current state of play, the crowd reaction, support for the player, or the like, in that situation. Therefore, whichever of the words is selected from a “box”, no sense of incompatibility is produced.

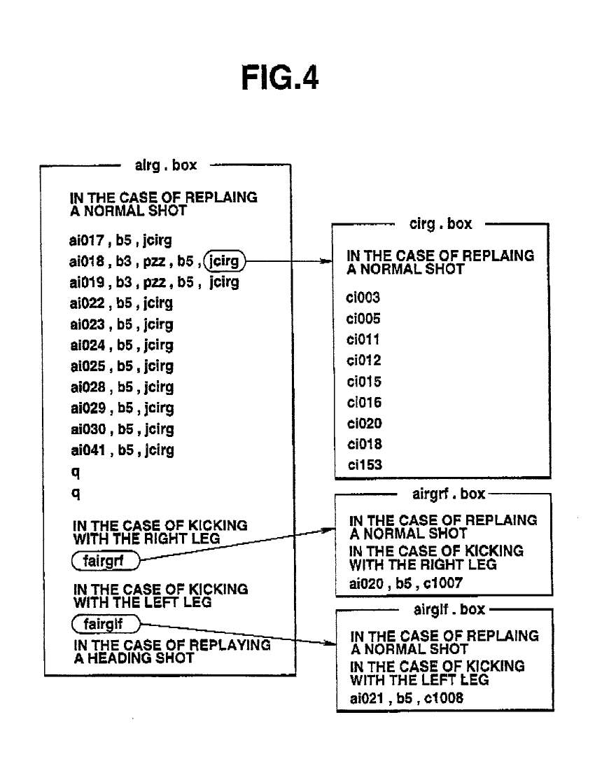

FIG. 4 shows the detailed structure of the “box” in FIG. 3, The “boxes” form a layered structure, whereby the device selects a “box” in accordance with the game conditions, and it then refers, further, to a subordinate “box”. By adopting a layered structure of this kind, it is possible to create a wide variety of running commentaries, in addition to which programming becomes simpler and memory is saved.

For example, in the case of: “Replaying a goal scored by a normal shot”, the “box”, airg.box, in FIG. 4 is selected. This box contains a plurality of words, “a017,b5,jcirg” . . . , “fairghd”. One of these words is selected at random.

The meaning of these words is now described taking as an example the words “ai018, b3, pzz, b5, jcirg”. This words is expressed in the form of text data. “ai018” is the “words number” for a specific words and has a five-digit structure: for example, a two-letter identification code, plus a three-digit number. Words data corresponding to this command is read out from the memory and a words of running commentary is reproduced. “b3” and “b5” are commands for creating an “interval (blank)” between two words. The numbers correspond to the length of the intervals.

“pzz” is a wild card for changing the words depending on the situation, for instance, the player's name or team name. For example, when recreating the words “(Player's name) is keeping close possession of the ball”, the device determines which player is in possession of the ball at that time, and uses the corresponding player's name. “Wild cards” are used for factors which change with the state of progress of the game, such as the “team name”, “player's name”, and the like, and for factors which do not change with the state of progress of the game, but which rather change continuously, or change with each game, such as the time elapsed or the player's numbers, or the like. By setting “wild cards” in this way for parameters which cannot be stipulated in advance in the program as constant figures or in a constant form, programming becomes more flexible and programming is simplified.

“jcirg” is a jump command which causes the device to jump to a different “box” after the words has been reproduced. In this example, the processing is transferred to box “cirg”. Any one of the commentator's words “ci003” . . . “ci153” in this box is selected at random.

In addition, there is also a “q” command, which is a quit command that suspends processing. When this command is selected, no words is reproduced. This words “q” serves to adjust the frequency of the running commentaries. If there was no words “q” at all, then the words of running commentary would continue without pause, which is bound to be an annoyance and cause the players to lose interest. Therefore, the words “q” is inserted, as appropriate. By adjusting the ratio of the words “q” to the other words, it is possible to adjust the level of running commentary (probability of speech generation).

Moreover, there is also the words “f”. This is a command which appends contents from another “box” to a words that is to be reproduced. For example, the words “fairgrf” indicates a shot taken with the right foot in the case of replaying a goal scored by a normal shot. Therefore, the device transfers to the box “airfgf.box” corresponding to this, and implements the words “ai020, b5, c1007”, and running commentary such as “He's so good with his right foot, isn't he?” is reproduced.

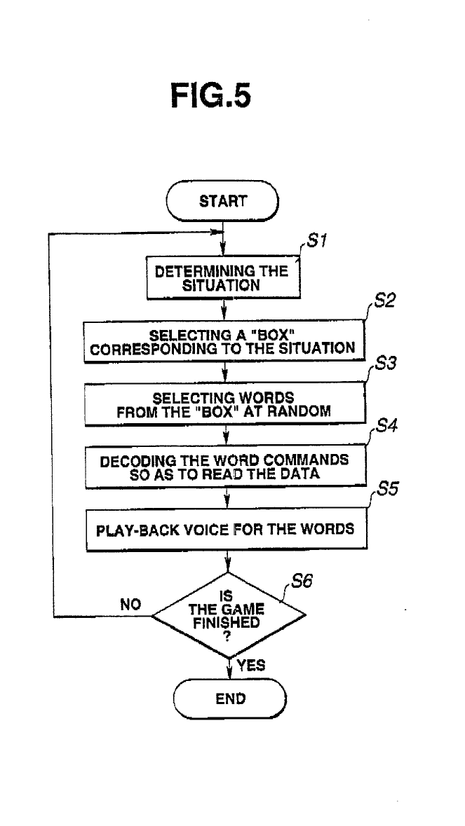

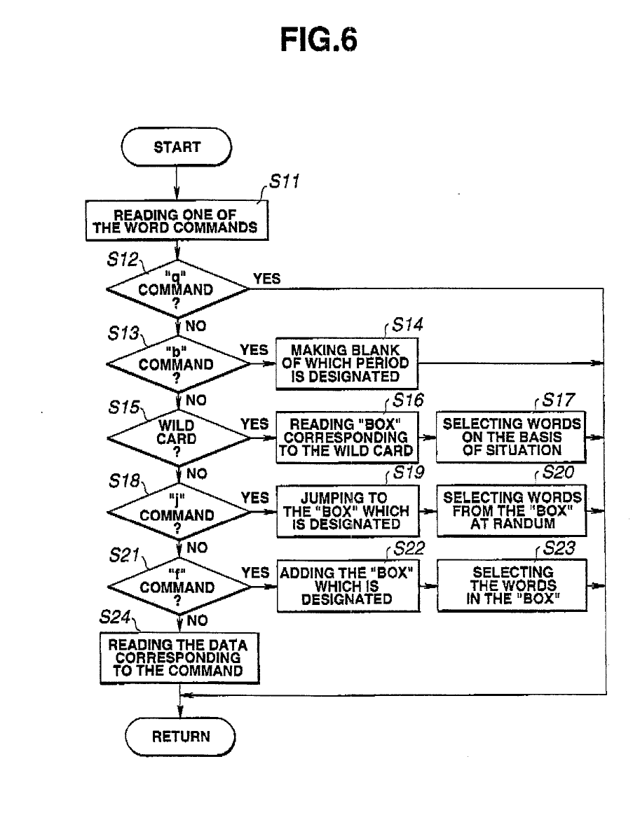

Next, the processing in a first mode for implementing this invention is described using the flow-charts in FIG. 5 and FIG. 6.

S1: The situation is determined and information relating to the conditions of the current processing, for example, in a soccer game, which player is in possession of the ball, what the player is doing, and the like, is received.

Conceivable examples of situations in a soccer game might include: “Start of match”, “Attack with own team in possession of ball”, “Defense with other team in possession of ball”, “Ball becomes dead as play is suspended”, “Restart as ball comes back into play”, “Goal scored”, “Shot misses”, “End of match”, and the like.

S2: A box corresponding to the received conditions is selected. This correspondence is set in advance in a table, or the like, so the device is able to identify the corresponding box simply, by referring to this table on the basis of the received conditions.

For example, in the situation “Start of match” in a soccer game, there is a pre-match greeting box, a match description box, and a commentator introduction box.

In the situation “Ball becomes dead as play is suspended”, there is a box for dead ball conditions, a box for immediately after the ball becomes dead, a replay screen box, and a box for when a player is sent off.

In the situation “Restart as ball comes back into play”, there is a restart conditions box, a throw-in, corner kick, free kick and goal kick box, a kick-off box, and a penalty kick box.

In the situation “Goal scored”, there are all the goal boxes, boxes for immediately after a goal, and a goal replay box.

In the situation “End of match”, there is a post-match comment box, and a closing comment box.

S3: A desired words group is selected from the corresponding box.

S4: The words command is decoded, and the corresponding words data is read out. Details of this processing are described below.

S5: A voice speaking the selected words is reproduced. The selected words data is transferred to a sound box 12 and after conversion to an analogue signal in a D/A converter 170, it is reproduced via the speakers 5a and 5b.

S6: The device verifies whether or not the match has ended: if it has ended, processing is terminated, and if it has not ended, the processing returns to S1 and continues.

Next, step S4 is described in detail, on the basis of FIG. 6.

S11: One words command selected at random is read out. Examples of words commands are shown in FIG. 4.

S12: The device determines whether or not the command read out is a “q” command. If it is a “q” command, then no words is reproduced, so the words reproduction processing is suspended and the device returns to the initial processing.

S13: The device determines whether or not the command read out is a “b” command. If it is a “b” command, then it advances to S14 and a specified interval is inserted between one words and the next. For example, if the command is “b3”, then an interval of 3 units is inserted, and if it is “b5”, then an interval of 5 units is inserted.

S15: The device determines whether or not the command read out is a “wild card”. If it is a “wild card”, then the device advances to S16, and reads a box corresponding to the “wild card” type. For example, if the “wild card” is “(team name)”, then it reads the “team name” box, and if the “wild card” is “(Player's name)”, then it reads the “player's name” box. The device then advances to S17 and selects a words on the basis of the situation. For example, if the words is “XXX are in good form . . . ”, then the name of the winning team is used for XXX, and if the words is “YYY has looked up and is dribbling the ball up-field”, then the name of the player dribbling the ball is used for YYY.

S18: The device determines whether or not the command read out is a “j” command. If it is a “j” command, then the device advances to S19 and jumps to the designated box. Thereupon, at S20, it selects at random one words group from the box.

S21: The device determines whether or not the command read out is an “f” command. If it is an “f” command, then it advances to S22, the designated box is appended, and at S23, a words from the box is selected. For example, if a player has taken a normal shot with their left foot, then the device jumps to the box for “left foot”, and a words such as “He's got a great shot with that left foot” is reproduced.

S24: The words command read out by passing through steps S12, S13, S15, S18 and S21 above, forms a file name for the words to be reproduced, and the device reads out words data corresponding to this words command and advances to step S5 in FIG. 5, where the words is reproduced.

As described above, according to a first mode for implementing this invention, since related words data is collected into “boxes” to form words groups, it is possible to reproduce a variety of words by means of simple processing, namely, selecting a corresponding box in accordance with the condition settings. Furthermore, the processing load does not become very large.

Moreover, since the words group selection in the box is conducted at random, even in the same state of the game, different words will be selected, so it is possible to prevent the game from becoming mannered, and the players will not become tired of the game.

Furthermore, since a “reproduce no words (q)” command is included in the words groups, words art not reproduced constantly, so annoyance is not caused. By adjusting the ratio of q commands, the words generation ratio can be adjusted simply.

Moreover, since “wild cards” are provided in parts of the words data, flexible processing can be achieved and programming is simplified, even in cases where there are parameters which cannot be specified beforehand in the program as constant numbers or in a constant form, namely, factors which change according to the state of progress of the game, such as “team name”, “player's name”, or the like, and factors which do not change according to the state of progress of the game, but change constantly, or change between games, such as the time elapsed or players' numbers.

Moreover, since the “boxes” have a layered structure and are composed such that, after selecting a “box” according to the conditions, the device then refers further to subordinate boxes, it is possible to reproduce a variety of running commentaries simply, in addition to which programming is simplified and memory is also saved.

Second Mode for Implementing the Invention

In a second mode for implementing this invention, a plurality of boxes, wherein a plurality of words corresponding to conditions are pooled, are provided for each commentator (announcer, or the like), and the device transfers to a different commentator's boxes as and when required. By means of this operation, the commentary voice can be changed, thereby providing a variety of commentators.

Furthermore, by changing the contents of the words boxes to a different language, it is possible to provide running commentary in two or more languages simply by means of prior switching of boxes, without modifying the structure of the system as a whole.

As described above, this device is applicable to games equipped with a function for conducting real-time description of the action of a game, using running commentary, and it comprises a running commentary system which outputs speech selected from boxes which hold words data groups classified according to conditions.

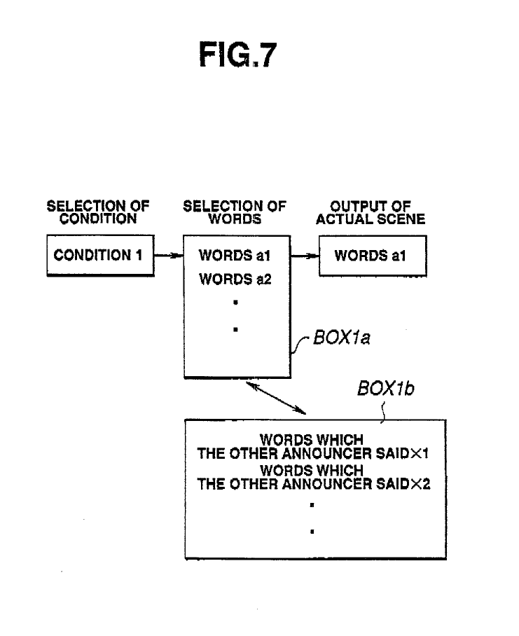

As shown in FIG. 7, a plurality of types of words corresponding to events, which may occur during a game and for which running commentary is required, are prepared (Type 2, Type 3, . . . ) and this plurality of words groups is stored respectively in corresponding boxes (BOX 1a, 1b). The specific composition of these boxes is similar to that illustrated in FIG. 4. Namely, the device in FIG. 7 is characterized in that, in addition to comprising a database of words groups for each of a set of particular conditions (Condition 1, Condition 2, . . . ), it is also provided with a further database of the same type, which is interchangeable therewith. A words is selected at random from the database (box) corresponding to the conditions in the game, and under particular conditions, the device switches database (box). In this case, by setting BOX 1a and 1b to the same data size, it is possible to switch between databases very simply in the program.

Conceivable examples for the plurality of databases (boxes) which should be prepared include the following.

“Database for live running commentary in English” and “Database for live running commentary in Japanese”

(Besides English, there is also German, French, Spanish, Portuguese, and the like.)

“Database for commentator A, who gives relaxed commentary” and “Database for commentator B, who gives exaggerated commentary”

“Male announcer database”, “Female announcer database”, “Announcer database”, “Analyst database”

Furthermore, the following examples may be given for the timing of database switching.

The players determine database switching by selecting the type of commentary at the game start-up screen.

The players determine database switching at an interval in the game, for instance, half-time,

Databases are switched automatically by means of a predetermined procedure, at an interval in the game. For example, after commentator A has said “Well, in the second half, we'll have commentary from B, who knows a lot about today's opponents”, commentator B then takes up the commentary.

Since the device determines at random which words is to be selected, as described above, when a words such as the foregoing is selected, the device detects this (by analyzing the command), and switches to databases for commentator B.

According to the first mode for implementing this invention, boxes comprising a collection of words corresponding to a condition can be prepared, and a plurality of expressions can be prepared for use in the same particular situation by selecting a words at random, in addition to which the device can be changed to a different language simply by means of prior switching.

The description above concerned the example of commentary for a soccer game, but this invention may naturally be used in other applications. For example, by switching database for each words, it is also possible to recreate a comic dialogue, or a commentary which interrupts a television program. In any of these cases, since the words are selected at random, there are constantly unexpected developments, and the players do not lose interest. Therefore, it is possible to provide a device and method which creates enormous variety.

As described above, according to this invention, since alternative words databases having different contents are provided for each of a plurality of words databases, and in predetermined cases, a words database is substituted by an alternative words database before processing is conducted, then it is possible to prepare a plurality of expressions for the same particular situation. Moreover, it is also possible to select a plurality of commentators.

Furthermore, according to this invention, since the language in the words databases and the language in the alternative words databases are different, it is possible to switch to a different language simply.

Moreover, according to this invention, since the words databases and the alterative words database are of the same size, programming is simplified.

The entire disclosure of Japanese Patent Application No. H9-17136 filed on Jan. 30, 1996 including specification, claims, drawings and summary are incorporated herein by reference in its entirety.

What is claimed is:

1. A speech generating device in a game device, comprising:
a plurality of phrase databases for storing a plurality of phrases respectively, corresponding to a plurality of predetermined conditions respectively;
a processing section for monitoring the state of progress of a game, selecting one or more of said plurality of phrase databases, which matches monitored condition, and selecting and outputting one or more data of said plurality of phrases from said selected phrase databases on the basis of a predetermined procedure; and
a speech output device for receiving said phrase data from said processing section, converting said phrase data to an audio signal and outputting speech on the bases of said audio signal.

2. A speech generating device in a game device according to claim 1, wherein said processing section randomly selects one of said plurality of phrase data.

3. A speech generating device in a game device according to claim 1, wherein said phrase databases include commands for suspending phrase generation such that no phrase is generated, and in the event of one of said commands for suspending phrase generation, said processing section suspends output of said phrase data to said speech output device.

4. A speech generating device in a game device according to claim 1, wherein said phrase databases include blank commands which provide an interval between adjacent phrases, and in the event of one of said blank commands, said processing section causes said speech output device to provide a period where output is suspended, corresponding to said blank command.

5. A speech generating device in a game device according to claim 1, wherein said phrase databases include wild cards where a specific phrase is not determined in advance, and in the event of one of said wild cards, said processing section determines a specific phrase for said wild card on the basis of the state of progress of the game, and outputs this phrase data to said speech output device.

6. A speech generating device in a game device according to claim 1, wherein at least one of said plurality of phrase databases comprise a first phrase database and a second phrase database related to this first phrase database, and said first phase database includes jump commands, and in the event of one of said jump commands, said processing section refers to said second phrase database designated by said jump command, selecting phrase data included in said second phrase database on the basis of a predetermined procedure.

7. A speech generating device in a game device according to claim 1, wherein at least one of said plurality of phrase databases comprise a first phrase database and a plurality of second phrase databases related to said first phrase database, and said first phrase database includes condition switching commands, and in the event of one of said condition switching commands, said processing section compares the state of progress of the game with said conditions, refers to the database of said plurality of second phrase databases which matches said state, and selects phrase data included in said second phrase database on the basis of a predetermined procedure.

8. A speech generating device in a game device according to claim 1, further comprising at least one of alternative phrase databases having different contents to said plurality of phrase databases, wherein said processing section selects and outputs phrases data corresponding to said conditions from said alternative phrase databases, instead of from said phrase databases, in predetermined cases.

9. A speech generating device in a game device according to claim 8, wherein said processing section selects phrases from said alternative phrase databases in accordance with selections made by a player.

10. A speech generating device in a game device according to claim 8, wherein said processing section selects phrase data from said alternative phrase database in the event of said selected phrase data including a database switching instruction.

11. A speech generating device in a game device according to claim 8, wherein at least a language of said phrase databases is different from a language of said alternative phrase databases.

12. A speech generating device in a game device according to claim 8, wherein at least a size of said phrase databases is the same as that of said alternative phrase databases.

13. A speech generating device in a game device, comprising:
a phrase database for storing a plurality of phrases, corresponding respectively to a plurality of predetermined conditions;
a processing section for monitoring a state of progress of a game, and selecting and outputting corresponding phrase data from said phrase database upon occurrence of predetermined conditions;
a speech output device for receiving said phrase data from said processing section, converting said phrase data to an audio signal and outputting speech on the basis of said audio signal; and
alternative phrase database including different contents to said phrase database,
wherein said processing section selects and outputs phrase data corresponding to said condition from said alternative phrase database, instead of from said phrase database, in predetermined cases.

14. A speech generating device in a game device according to claim 13, wherein said processing section selects phrase data from said alternative phrase database in accordance with selections made by a player.

15. A speech generating device in a game device according to claim 13, wherein said processing section selects phrase data from said alternative phrase database in the event of said selected phrase data including a database switching instruction.

16. A speech generating device in a game device according to claim 13, wherein at least a language of said phrase database is different from a language of said alternative phrase database.

17. A speech generating device in a game device according to claim 13, wherein at least a size of said phrase database is the same as that of said alternative phrase database.

18. A medium whereon programs for causing a computer to function as a processing section and speech output device according to any of claims 1 to 17 are stored.

19. A speech generating method in a game device comprising:
a phrase data selecting step for monitoring a state of progress of a game and, in the event of predetermined conditions arising, selecting and outputting corresponding phrase data from a plurality of databases wherein a plurality of phrases corresponding respectively to a plurality of predetermined conditions are stored; and
a speech outputting step for receiving said phrase data outputted, converting said phrase data to an audio signal and outputting speech on the basis of said audio signal.

20. A speech generating method in a game device according to claim 19, further comprising an alternative phrase data selecting step for selecting and outputting phrase data corresponding to the conditions from alternative phrase databases, which have different contents to said phrase databases, instead of from said phrase databases, in predetermined cases.

21. A speech generating method in a game device according to claim 20, wherein said alternative phrase data selecting step select phrase data from said alternative phrase databases in accordance with selections made by a player.

22. A speech generating method in a game device according to claim 20, wherein said alternative phrase data selecting step selects phrase data from said alternative phrase databases when the phrase data from said selected phrase database includes a switching signal.
